(19) United States
(12) Patent Application Publication
(10) Pub. No.: US 2013/0052903 A1
(43) Pub. Date: Feb. 28, 2013

(54) PLASMA BULB SEALING WITHOUT A HYDROGEN FLAME

(71) Applicants: Richard Gilliard, Morgan Hill, CA (US); Abdeslam Hafidi, Cupertino, CA (US); Thomas O'Halloran, Sunnyvale, CA (US); John F. Waymouth, Marblehead, MA (US)

(72) Inventors: Richard Gilliard, Morgan Hill, CA (US); Abdeslam Hafidi, Cupertino, CA (US); Thomas O'Halloran, Sunnyvale, CA (US); John F. Waymouth, Marblehead, MA (US)

(73) Assignee: Luxim Corporation, Sunnyvale, CA (US)

(21) Appl. No.: 13/218,014

(22) Filed: Aug. 25, 2011

(51) Int. Cl. H01J 9/26

(52) U.S. Cl. 445/44

(57) ABSTRACT

An electrodeless plasma lamp and method of forming a seal on an electrodeless bulb for use in the plasma lamp are described. The method may include providing a section of tube, cutting the tube to length, and sealing a first point on one end of the tube in a rounded fashion to form a first end of the electrodeless bulb. The cross-sectional diameter of an opposite end of the tube is reduced to form a tail on the electrodeless bulb. The tail is open to an interior portion of the bulb where the interior portion forms a cavity. One or more fill gases are injected into the cavity of the bulb. A first portion along the tail of the bulb is sealed thereby forming a truncated tail. A second point on the tail, intermediate between a terminal portion of the tail and a portion of the bulb containing the cavity, is sealed. The second point is sealed with a plasma torch by using an inert-gas element with a minimum of hydrogen gas.

### FIELD

The field relates to systems and methods for generating light and, more particularly, to preparation and sealing bulbs used in electrodeless plasma lamps.

### BACKGROUND

Electrodeless plasma lamps may be used to provide bright, white light sources. Because electrodes are not used, they may have longer useful lifetimes than other lamps. Electrodeless plasma lamps use a fill in a bulb that is excited to produce a light-emitting plasma. One of the manufacturing processes to fabricate the plasma lamp involves hermetically sealing the bulb to prevent various chemicals placed, or dosed, within the bulb from escaping. However, contemporary sealing techniques use a hydrogen/oxygen torch to produce a final seal on the bulb. With time, hydrogen diffuses through the bulb walls into the interior of the bulb. The increased hydrogen concentration within the bulb require increasingly higher voltages and power levels to ignite a plasma within the bulb, thereby putting a heavier burden on the driver to maintain reliability and voltage.

### BRIEF DESCRIPTION OF THE DRAWINGS

Various ones of the appended drawings merely illustrate example embodiments of the inventive subject matter and cannot be considered as limiting its scope. In the figures and description, numerals indicate the various features of example embodiments, like numerals referring to like features throughout both the drawings and description. In the drawings,

FIG. 1 shows an example bulb with a tail;

FIGS. 2A through 2E show an example tube and bulb at various stages in a filling and sealing process;

FIGS. 3A through 3C show concentration levels of hydroxyl (OH) in three quartz bulbs measured after 1000 hours of testing;

FIG. 4 is a flowchart of an example method for filling and sealing the bulb;

FIGS. 5A through 5C are example systems for making a final seal on the bulb; and

FIG. 6 shows an example plasma lamp including the bulb of FIG. 5.

### DETAILED DESCRIPTION

While the present invention is open to various modifications and alternative constructions, various embodiments shown in the drawings will be described herein in detail. It is to be understood, however, there is no intention to limit the invention to the particular example forms disclosed. On the contrary, it is intended that the invention cover all modifications, equivalences, and alternative constructions falling within the spirit and scope of the invention as expressed in the appended claims. Additionally, as used herein, the conjunctive term “or” may be construed in either an inclusive or exclusive sense.

In an example embodiment, an electrodeless plasma lamp and method of forming a seal on an electrodeless bulb for use in the plasma lamp are provided. The method may include providing a section of tube, cutting the tube to length, and sealing a first point on one end of the tube in a rounded fashion to form a first end of the electrodeless bulb. The cross-sectional diameter of an opposite end of the tube is reduced to form a tail on the electrodeless bulb. The tail is open to an interior portion of the bulb where the interior portion forms a cavity. The bulb is then placed into a high purity environment and baked at a high temperature. After cooling, chemical doses are added into the bulb. One or more fill gases are injected into the cavity of the bulb. A first portion along the tail of the bulb is sealed thereby forming a truncated tail. The bulb is removed from the high purity environment and a second point on the tail, intermediate between a terminal portion of the tail and a portion of the bulb containing the cavity, is sealed. The second point is sealed with a plasma torch by using an inert-gas element with a minimum of hydrogen gas.

In an embodiment, a system to form a seal on an electrodeless bulb for use in a plasma lamp is provided. The system may comprise a plurality of torches to direct only an inert-gas element as a discharge gas through each of the plurality of torches. A plasma may be formed through ohmic heating of the discharge gas of the inert-gas element from each of the plurality of torches. The plasma may create sufficient heat to soften and collapse a tubulation of the electrodeless bulb. In example embodiments, a rotational mechanism is used to provide relative rotational movement between the electrodeless bulb and the plurality of torches.

In an example embodiment, the system comprises a cooling bath to cool the bulb to cryogenic temperatures and a plurality of torches. The plurality of may torches produce a substantially uniform heat on a tail of the bulb. Each torch in the plurality of torches may be positioned or placed at a substantially equiangular positions so that adjacent torches are equally spaced. Each torch may direct only an inert-gas element as a discharge gas. A plasma may be formed through ohmic heating of a discharge of the inert-gas element from each of the plurality of torches. The plasma creates sufficient heat to soften, collapse, or otherwise suitably deform or shape the tail of the electrodeless bulb.

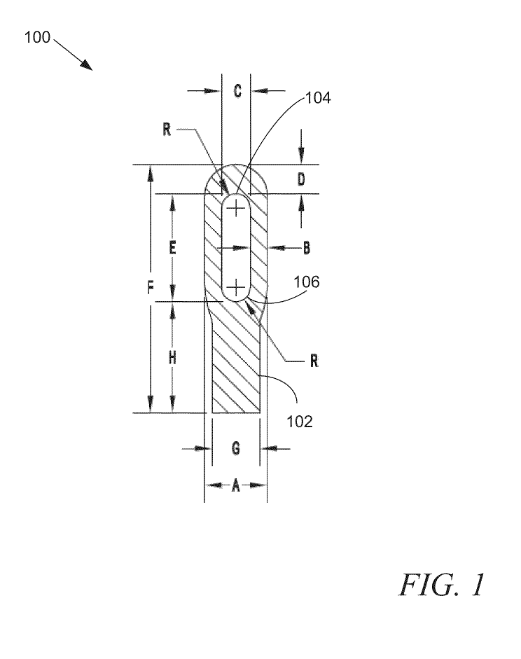

FIG. 1 shows an example bulb 100 with a tail 102. The bulb 100 may be fabricated from quartz, sapphire, ceramic, or another material suitable for bulb used in an electrodeless plasma lamp. The bulb 100 may be cylindrical, pill-shaped, spherical, or another desired shape. In the example embodiment shown in FIG. 1, the bulb 100 is cylindrical in the center and forms a hemisphere at each internal end 104, 106. In one example, the outer length, F, (from tip-to-tip) is about 11 mm and the outer diameter, A, (at the center) is about 5 mm. In this example, the interior of the bulb 100 (which contains the chemical fill, discussed below) has an interior length, E, of about 7 mm and an interior diameter, C, (at the center) of about 3 mm. The internal radius R at each internal end 104, 106 of the bulb is about 1.1 mm. A wall thickness, B, is about 1 mm along the sides of the cylindrical portion and about 2.25 mm on each end (e.g., at dimension D). In other examples, a thicker wall may be used. In other examples, the wall may be between 2 mm to 10 mm thick or any range included therein. In other example embodiments, the bulb 100 may have an interior width or diameter in a range between about 2 mm and 30 mm or any range included therein, a wall thickness in a range between about 0.5 mm and 4 mm or any range included therein, and an interior length between about 2 mm and 30 mm or any range included therein. In example embodiments, the interior of the bulb 100 has a volume in the range of about 10 mm³ to 750 mm³ or any range included therein. In some examples, the bulb 100 has an interior volume of less than about 100 mm³ or less than about 50 mm³. These dimensions are examples only and other embodiments may use bulbs having different dimensions or shapes.

As further shown in the example of FIG. 1, the bulb 100 may have the tail 102 extending from one end of the bulb 100. Although FIG. 1 shows only a single tail 102, other examples may include a tail on each end of the bulb 100 or no tail at all. In some embodiments, the length, H, of the tail 102 may be between about 5 mm and 25 mm or any range included therein. In some embodiments, a longer or shorter version of the tail 102 may be used. In some embodiments, the diameter G of the tail 102 may be from about 2 mm to 4 mm or any other range included therein. As described in more detail, below, the tail 102 may be formed by using a quartz tube used to form the bulb 100.

Briefly, the quartz tube may be sealed at one end, which forms the front end of the bulb 100 (e.g., near dimension D). The bulb 100 may be filled through an open end of the tube and sealed. In an example embodiment, the sealed tube is then placed in a liquid nitrogen bath, and a torch is used to collapse the tube at the open end of the bulb 100. The torch may thus seal the bulb 100 and form the tail 102. The collapsed tube may then be cut to a desired tail length.

In example embodiments, the bulb 100 contains a fill that forms a light emitting plasma when RF power is coupled to the bulb 100. The fill may, for example, include a noble gas and a metal halide. Additives such as mercury may also be used. An ignition enhancer may also be used. A small amount of an inert radioactive emitter, such as Kr₈₅, may be used for this purpose. In other embodiments, different fills such as sulfur, selenium, or tellurium may also be used. In some example embodiments, a metal halide such as cesium bromide may be added to stabilize a discharge of sulfur, selenium, or tellurium.

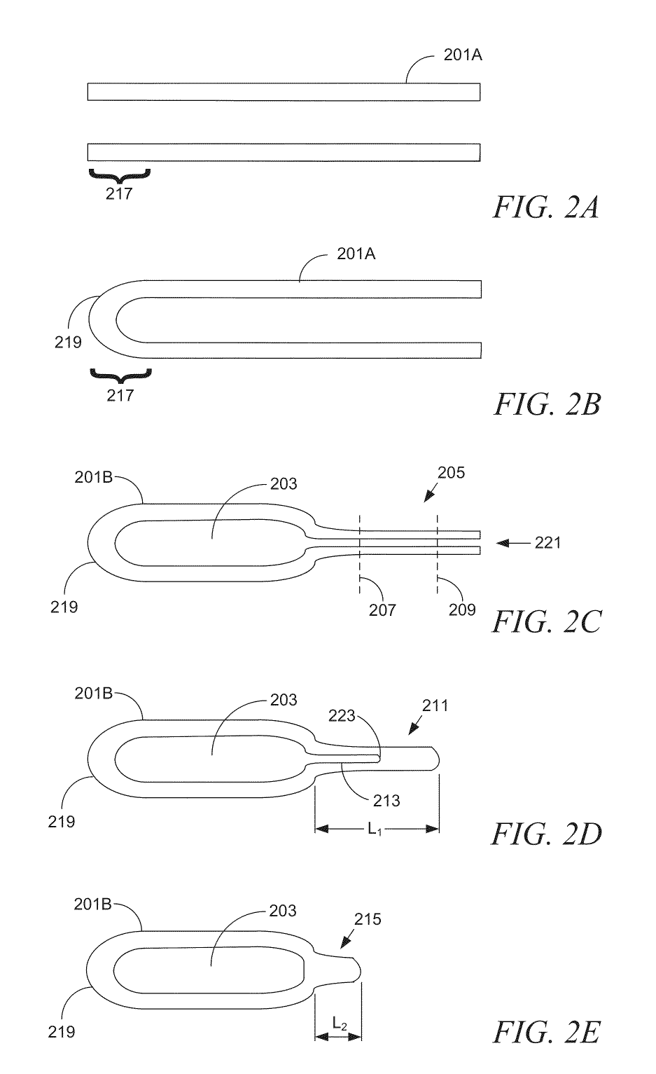

Referring now to FIGS. 2A through 2E, an example of a tube 201A and a bulb 201B (shown in cross-section) are shown at various stages in a filling and sealing process. The bulb 201B is formed from the tube 201A by heating and deforming various portions of the tube 201A as discussed, by way of example, below with reference to FIGS. 2B through 2E.

With reference to FIG. 2A, in an embodiment, the tube 201A may be fabricated from quartz, sapphire, ceramic, or another material suitable for bulb used in an electrodeless plasma lamp. A first portion 217 of the tube 201A is deformed or collapsed to seal one end of the tube 201A. The deforming or collapsing may occur by, for example, heating the first portion 217 of the tube 201A on a glass lathe. After the deforming or collapsing of the first portion, a first sealed end 219 is formed as shown in FIG. 2B. Similar steps or operations may be applied to a tail portion 205 as shown in FIG. 2C. However, the tail portion 205 is not fully collapsed and is therefore not sealed at this point in the process. The tail portion 205 is left as an open end 221, for later dosing operations as discussed in more detail, by way of example, below. In an embodiment, with the first sealed end 219 and the tail portion 205 formed, the bulb 201B is at least partially formed. In an example embodiment, the bulb 201B may be circularly cylindrical in cross section.

In an example shown in FIG. 2C, the bulb 201B is shown to include an interior portion 203 and the tail portion 205. The interior portion 203 forms a cavity within the bulb 201B. The bulb 201B of FIG. 2C is also shown to include two points at which seals may be made. In an example embodiment, the tube 201B is placed in a high purity, ultra-clean environment, such as in an argon-filled glove box. A seal is formed at a first seal point 209 on the tail portion 205 of the bulb 201B to provide a temporary seal and may also shorten the length of the tail portion 205 as shown by an arrow 211 (FIG. 2D). Thereafter, a second seal at a second seal point 207 is formed to create a permanent seal for the bulb 201B. During formation of the second seal, the tail portion 205 may be further shortened as shown by an arrow 215 (FIG. 2E).

Accordingly, in an example embodiment, sealing of the bulb 201B is performed as a two-step process. Prior to the first step of the two-step process, the bulb 201B is chemically dosed through the open end 221 of the bulb 201B (FIG. 2C). In example embodiments, the bulb 201B is chemically dosed with a fill that forms a light emitting plasma when RF power is applied to the bulb 201B. The fill may include a noble gas and a metal halide. Additives to the fill, such as mercury, may also be used. An ignition enhancer may also be used. For example, a small amount of an inert radioactive emitter, such as Kᵣ₈₅, may be used for this purpose. In other embodiments, different fills such as sulfur, selenium, or tellurium may also be used. In some example embodiments, a metal halide such as cesium bromide may be added to stabilize a discharge of sulfur, selenium, or tellurium.

Chemical dosing of the fill in the bulb is performed under conditions of a high purity, ultra-clean environment, such as in an argon-filled glove box. After the bulb 201B is filled, a first seal at the first seal point 209 is usually carried out in the ultra-clean environment. The seal may be formed by applying a high temperature source, such as a rare-gas plasma using the glove box environment or an induction heater, to the tail portion 205 of the bulb 201B. The high temperature source may soften and collapse the tail portion 205 of the bulb 201B. In an example embodiment, the first seal closes the bulb 201B after introduction of the chemical dose and rare gas fill into the bulb chamber. The first seal forms a hermetic seal 223. A length of the first seal is generally made longer than necessary. In an example embodiment, a length, L₁, of the first seal may be from 5 mm to 50 mm (as measured along the longitudinal axis of the bulb 201B) from the bulb surface.

After the first seal is formed, the bulb 201B, now at least partially sealed, may then be cryogenically cooled to approximately −100° to −200° C. to at least inhibit (ideally prevent) the fill from evaporating due to the heat applied to the bulb 201B during the sealing process. To achieve the low cryogenic temperatures, the sealed tube may be placed in a liquid nitrogen bath. The temperature of the liquid nitrogen bath, or other cooling means, helps keep the fill in the bulb 201B. A torch is used to collapse the tube at the open end 220 of the bulb 201B. The torch may then seal the bulb 201B (FIG. 2D).

In some example embodiments, a high-pressure fill is used to increase the resistance of the gas at startup when the fill in the bulb 201B is ignited. The increased resistance can be used to decrease the overall startup time required for the bulb, and hence the plasma lamp, to reach full brightness for steady state operation of the plasma lamp. In one example embodiment, a noble gas such as neon, argon, krypton, or xenon is forced into the bulb 201B at high pressures between 200 Torr to 3000 Torr or any range included therein. Pressures less than or equal to 760 Torr may be desired in some embodiments to facilitate filling the bulb 201B at or below atmospheric pressure. In certain embodiments, pressures between 100 Torr and 600 Torr are used to enhance starting. Example high-pressure fills may also include metal halide and mercury which have a relatively low vapor pressure at room temperature. By keeping the pressures within the bulb 201B at less than 760 Torr (approximate atmospheric pressure), the tail portion 205 of the bulb 201B may collapse inwards when the high temperature source (e.g., the torch) is applied at the first seal point 209.

After the first seal is completed, the bulb 201B (see FIG. 2D) can then be removed from the ultra-clean environment chamber (e.g., the glove box). Although processes subsequent to the first seal may still be performed within the ultra-clean environment chamber, the additional processes may be more easily carried out in an environment less physically restricting than the glove box. For example, the subsequent permanent seal further shortening the tail of the bulb (see arrow 215 in FIG. 2E) may require higher power equipment. Generally, there is insufficient room in a conventional glove box for the high power equipment and associated sealing systems (described, by way of example, in more detail, below). Accordingly, after the first seal has been completed, the bulb may be removed from the glove box, and the second seal is formed, at the second seal point 207 with the hermetic seal 223 intact.

One purpose of forming the second seal is to enhance the symmetry of the interior of the bulb. In an example embodiment, the second seal is formed in such a fashion so that an interior of the bulb does not include (or reduced the volume of) any hollow passages 213 (see FIG. 2D) extending into the tail portion 205 of the bulb 201B. In an example embodiment, a temperature of the bulb is isothermal throughout its interior surface. Under isothermal conditions (e.g., no cold spots), light output from the bulb increases for a given input power. The output of a high-pressure discharge lamp is related to the temperature of the coldest point on the interior of the bulb surface, the so-called cold spot, because the cold spot is the site where the dose chemicals, such as metal halides and mercury, condense. In example embodiments, the higher the cold spot temperature, the more light output produced because of the increased vapor pressure of the radiating materials. A function of the input power includes heating the cold spot to a sufficiently high temperature through ohmic self-heating of the plasma such that large quantities of light are generated. Since the hollow passages 213 (e.g., in the tail portion 205) are farther from heat generated by the operating plasma while the bulb 201B is operating, the hollow passages 213 can act as local condensation points (cold spots) for the metal halide (or other fill) materials.

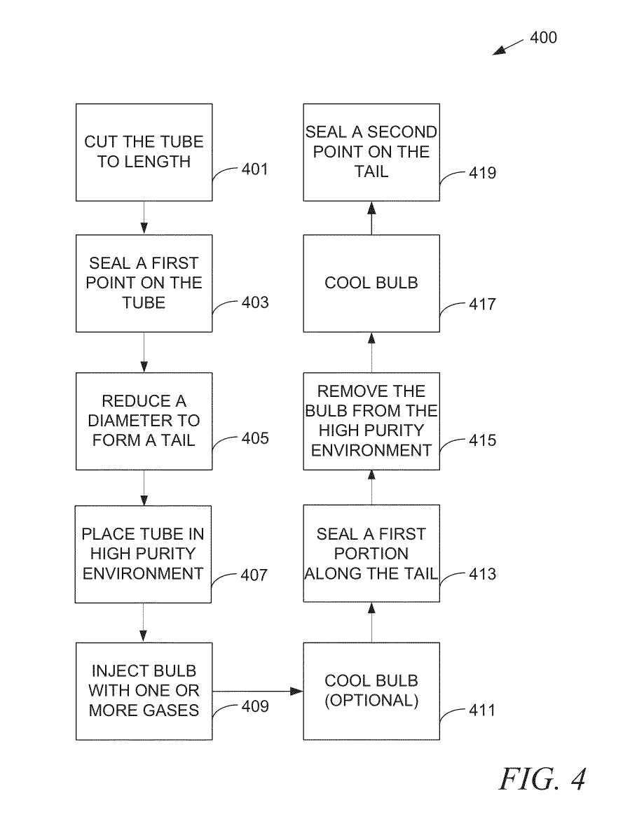

With reference to FIG. 2E, the final sealing process may be carried out on a precision rotating apparatus that brings a high temperature flame to the bulb surface at the second seal point 207 (FIG. 2C). The high temperature flame may thus produce the second and final seal, further shortening the tail portion 205 as indicated by an arrow 215. A length, L₂, of the tail indicated by the arrow 215 may be from 1 mm to 10 mm. As described in more detail, by way of example, with reference to FIGS. 4A through 4C, below, the flame may include a rotating set of torches in lieu of rotating the bulb itself. In an example embodiment, the interior portion 203 of the bulb 201B is generally kept at a low temperature (by means of, for example, a liquid nitrogen bath or other means) in order to ensure that fill materials remain condensed within the bulb during the high temperature sealing process. Further, by keeping a temperature of the bulb 201B low (e.g., on the order of −100° C. to −200° C.) the interior portion 203 of the bulb 201B is kept at negative pressure so that the outside atmospheric pressure will enable a terminal end of the tail portion 205 to soften and collapse, as discussed above.

In an example embodiment, the high-temperature flame is produced by a hydrogen/oxygen torch. The hydrogen/oxygen torch may bring a well-directed blast of heat at very high temperature to a quartz bulb, thereby enhancing a reliable and reproducible seal on the quartz body. Due to the high temperature of the hydrogen/oxygen torch, the quartz bulb may seal quickly (e.g., less than 1 second) thus making feasible the near cryogenic cooling of the bulb interior, only millimeters away from the seal itself. In certain circumstances, a requirement of a rapid collapse and consequent need for a large amount of heat in a very short time is even greater in the case where a glass-to-metal seal is required.

However, it is believed that a disadvantage of using a hydrogen/oxygen torch for the final closure is that this type of hydrogen/oxygen seal brings hydrogen and water (a by-product of the reaction) in direct contact with the bulb at high temperature. As is well known to one of skill in the art, quartz is permeable to hydrogen at high temperatures. Accordingly quartz, which is often used for these types of lamps, is typically formed in the absence of hydrogen and, after being formed into tubing, is typically baked in a vacuum environment around the annealing point of quartz (approximately 1140° C.) for 40 hours or more in order to remove any residual hydrogen (H₂) or hydroxyls (OH).

A problem exhibited by the hydrogen impurity is its tendency to result in electron attachment in a non-operating lamp (particularly at low temperatures), making ignition of the fill to form a plasma more difficult. Thus, the

HBr+e⁻→H+Br⁻

The presence of bromide vapors in the gas fill at ignition may introduce significant electron attachment, which reduces the effective ionization rate. The bromide vapors require an increase in electric field required for breakdown and ignition. The principal problematic bromide is the diatomic molecule, hydrogen bromide (HBr). HBr is formed by a reaction of water (H₂0) or gaseous hydrogen (H₂) with bromide salts. The primary source of H₂0 is residual moisture in the salts themselves or adsorbed water on the highly-hygroscopic salts and is incompletely removed during processing. The primary source of H₂ is OH in the quartz or the H₂O in the outer atmosphere, which is dissociated by ultraviolet radiation during operation of the bulb. The ultraviolet radiation frees hydrogen to diffuse through the quartz walls and into the interior of the bulb. Typical chemical reactions forming HBr are:

3H₂O+2HoBr₃→Ho₂O₃+6HBr

3H₂+2HoBr₃→2Ho+6HBr

Note that in each case two moles of HBr are formed per mole of hydrogen impurity. Calculations indicate that 0.18 μm of H₂0 in the salts or 2.5 ppm OH in the quartz can produce sufficient HBr to increase breakdown field strength (for forming the plasma) by 10% and the breakdown power is increased by 20%. In studies performed on quartz bulbs after 1000 hours of operation, the OH concentrations in the bulbs ranged from approximately 12 ppm in the bulb walls to approximately 50 ppm near the tail-to-bulb connection. The study concluded that OH concentrations were approximately 10% to 50% higher after the extended bulb operation.

Most electroded (in contrast to electrodeless) metal halide lamps use igniters which can supply a high electric field (in the form of voltage) for breakdown. In the case of the few metal halide lamps that operate without an outer jacket, an inability to ignite as the lamp ages has not been a clearly defined issue, primarily because ignition difficulties over time have typically been assumed to be dominated by other more dominant factors such as electrode deformation and loss of emission materials (e.g., failure of thorium transport cycle). In addition, these electroded lamps often come in a double-ended configuration that enables exceptionally high voltages for breakdown without the risk of external breakdown between outer leads.

However, test results show that in the case of a plasma lamp (without electrodes or an outer jacket) without high voltage delivered by an external igniter, there is a buildup of inward diffusing hydrogen in the bulb as the lamp ages. This is evidenced by various test data. For example, the measured OH concentration in the quartz tubing before forming into a lamp is typically less than one part per million based on Fourier Transform Infrared (FTIR) Spectrometer analysis of the material. After bulb forming, the concentration is measured as five ppm using the same technique. The rise may be as a result of hydrogen diffusing into the quartz from the hydrogen/oxygen torch used for the sealing process. After 1000 hours of aging the level increases to approximately 10 ppm, apparently from inward diffusion of the hydrogen from the atmospheric water. Further aging shows a slight further increase in OH is measured (approximately 1 ppm increase in the next 600 hours). Furthermore, the required forward power for ignition shows a corresponding increase as the lamp ages.

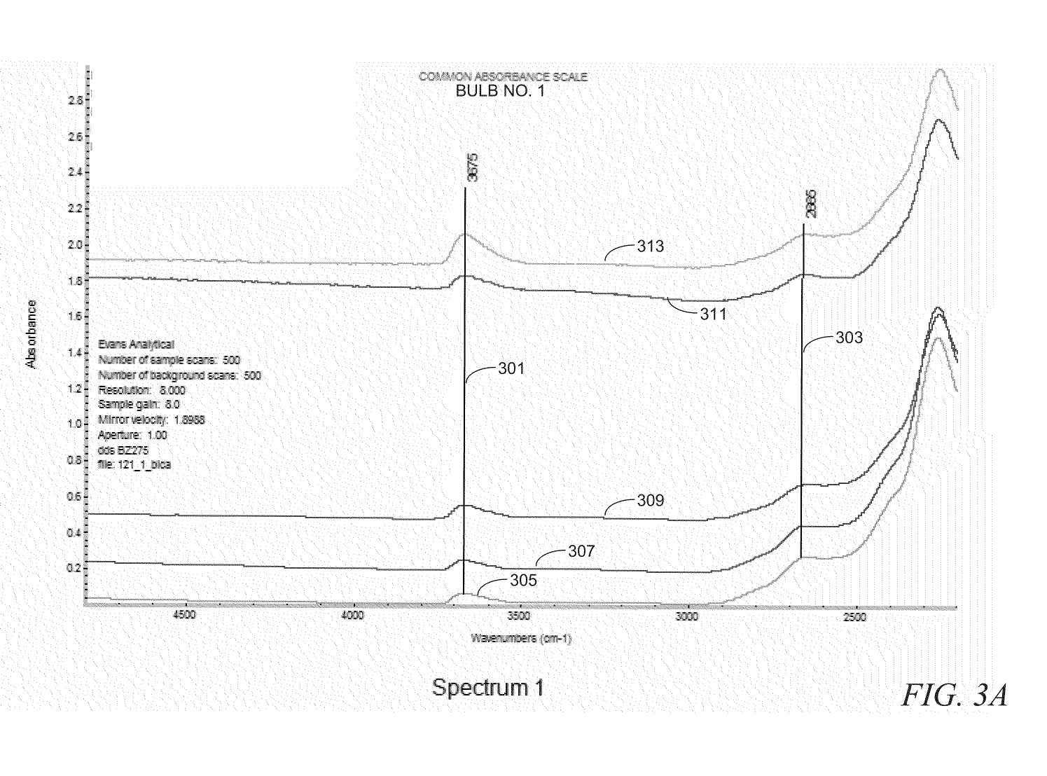

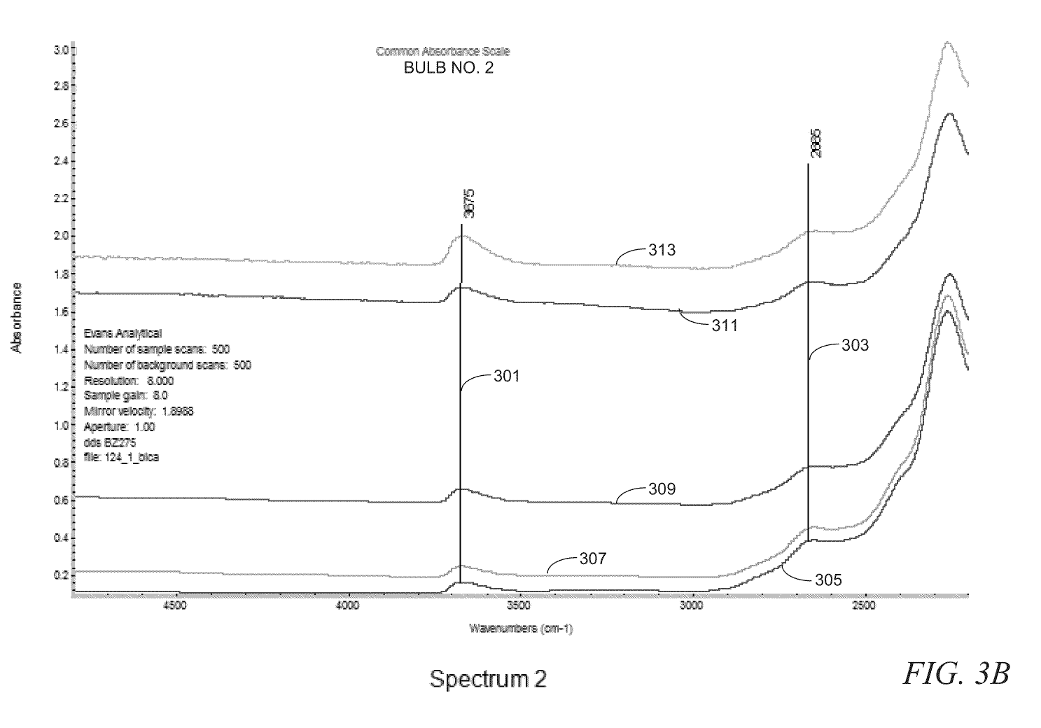

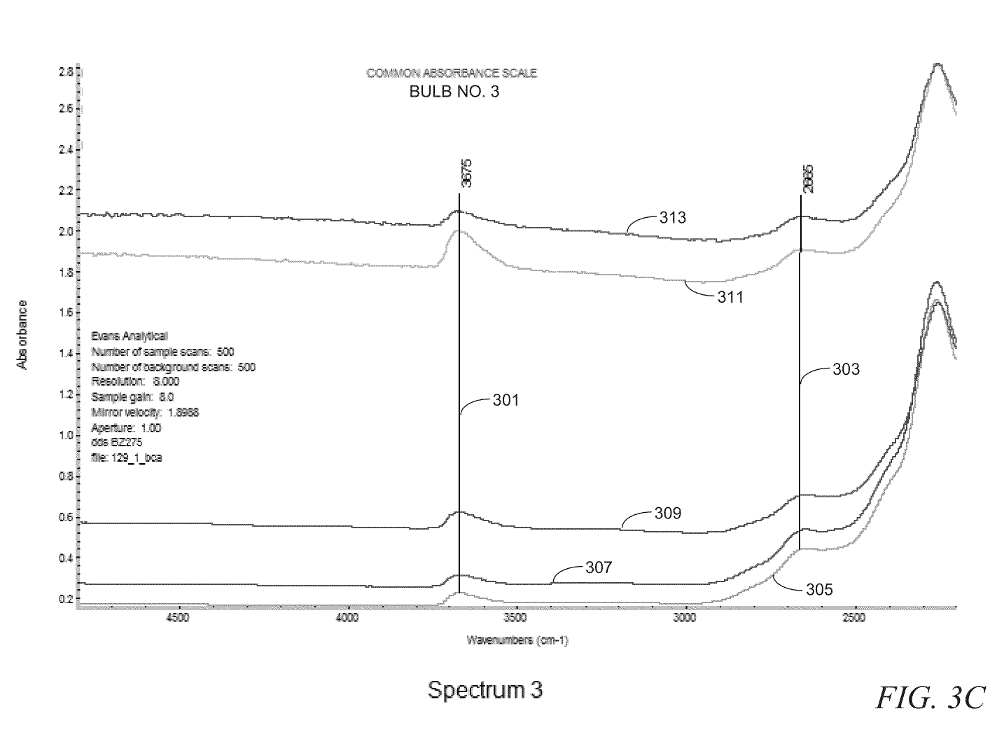

With reference to FIGS. 3A through 3C, concentration of OH in three example quartz bulbs were measured after 1000 hours of testing. Each of the three quartz bulbs was placed vertically in the main bench of an FTIR Spectrometer. An FTIR spectrum of each of the quartz bulbs was then recorded in transmission mode and displayed in absorbance format. Suitable apertures were used to limit the beam to regions of interest in the samples. Spectra from the regions of interest indicate a plot 305 from near the bulb center, another plot 307, also near the bulb center, a plot 309, at the first sealed end of the bulb, a plot 311 at the tail seal of the bulb, and a plot 313 near the first sealed end. Locations of the measured spectra from each of the respective bulbs is similar for all three bulbs (as indicated in each of FIGS. 3A through 3C). FIGS. 3A through 3C show the FTIR spectra, in overlay format on constant absorbance scales, of the three bulbs at various positions. The bulbs each exhibited characteristic OH, at approximately 3675 cm⁻¹, as indicated at line 301, and silicon dioxide (SiO₂), at approximately 2665 cm⁻¹, as indicated at line 303, wavenumber bands typical of quartz.

Major differences between FIGS. 3A, 3B, and 3C were the upward or downward translation of baseline data (not shown), measured prior to the bulbs operating for 1000 hours. The translations of the date may be due to differences in the overall light transmission at the measurement locations (geometric effects) or to coatings on the walls. Consequently, the substantially increased concentrations of OH are indicative of hydrogen contamination in the bulb. As discussed above, ignition of a plasma within the bulb becomes increasingly difficult as the bulb ages and hydrogen concentration levels increase.

In an example embodiment, a key to eliminating (or at least reducing) the initial diffusion of hydrogen into the bulb is to avoid the use of a hydrogen/oxygen torch for sealing. At the same time, sealing the bulb must occur by rapidly creating highly localized (or directed) temperatures sufficient to raise the quartz to temperatures in excess of 1800° C. in a non-contaminating environment. Example embodiments utilize jets of plasma using an inert gas, such as argon, by means of ohmic heating (electrical conduction) through the gas. Various example embodiments for the sealing technology are described. The actual geometry of the bulb itself or the fill materials or gases inserted into the bulb are substantially independent of the seal technology.

With reference now to FIG. 4, a flowchart of an example method 400 for forming, filling, and sealing the bulb is shown. The example method 400 may be deployed to produce the bulb as shown in FIGS. 1 and 2 and accordingly, merely by way of example, is defined with reference to this bulb but not limited to this bulb.

At operation 401, a tube is cut to length. The length of the tube may be determined by various dimensions given for the bulb, by way of example, with reference to the dimensions given in FIG. 1.

At operation 403, the initial steps in forming the bulb from the tube begin. A first point on one end of the tube is sealed on a glass lathe to form a first end of a resulting bulb. The seal forms the tube in a rounded fashion as indicated by the first sealed end 219 of FIG. 2C. A cross-sectional diameter of an opposite end of the tube is reduced, at operation 405, to form a tail on the bulb. The tail is left open to an interior portion of the bulb at this point on the process. The interior portion is a cavity within the bulb.

In other embodiments, for example, where a larger bulb is required, the bulb may be formed from alumina (Al₂O₃) as discussed above. The alumina bulb is provided with one sealed end and an open end. The tube may be welded or otherwise attached to the alumina bulb on the open end to form a tail on the alumina bulb. The remainder of the operations are then carried out as discussed herein.

At operation 407, the tube is placed in a high purity, ultra-clean environment, such as in an argon-filled glove box. The glove box allows for initial processing of the bulb such as dosing (inserting the fill) and forming a first initial seal (see, for example, FIG. 2D). The glove box allows the processes to be carried out with a low likelihood of contaminants being sealed within the bulb (e.g., the bulb 201B). Once placed in the glove box, the bulb may be initially prepared in a vacuum baking process to remove or reduce the level of residual hydrogen from prior processing and handling. After the vacuum baking process, the bulb may then be allowed to cool inside the glove box.

At operation 409, the bulb is filled with appropriate chemicals by first evacuating gas (e.g., argon as may be found in the glove box) from the bulb and then filling the bulb with a chemical dose and one or more appropriate fill gases on a closed system within the glove box. The fill allows the bulb to form a light emitting plasma when RF power is applied to the fill during operation of the plasma lamp. The fill may include, for example, a noble gas and a metal halide.

After the fill operation, the bulb may then optionally be cooled, at operation 411, prior to making the first seal of the bulb. Having the first seal left long limits heats conduction to where the condensable fill materials are located (distal to the seal) and helps ensure that the fill materials remain condensed within the bulb during the subsequent sealing operation. Further, the interior of bulb is kept at a low pressure (negative pressure with respect to atmospheric pressure within the glove box) due to the cooling operation. The low pressure helps ensure that the quartz tube, from which the bulb is formed, collapses inward and hermetically seals the bulb during the first seal operation since the interior pressure in the bulb is less than atmospheric pressure in the glove box.

At operation 413, while the bulb is still in the closed system utilized for the evacuation and gas fill, the first seal may be made on the bulb by heating and deforming the tail portion formed at operation 407. The tail is heated by using an a high temperature inert gas plasma jet from a plasma torch (an inert-gas arc). The temperature of the arc is generally greater than 1800° C., to soften and allow the material of the tail to collapse, but less than 3000° C., to avoid melting the material (e.g., the quartz). In an example embodiment, the inert-gas arc is composed of the gas placed in the glove box (e.g., argon). The bulb is thus sealed by being collapsed upon itself due to the heating of the tail and the negative pressure inside the bulb. The seal produces the hermetic seal 223 with a shortened or truncated tail that is left on the bulb (see FIG. 2D). The tail after forming the first seal may have a length, L₁, of at least about 5 mm to 50 mm (see FIG. 2D).

At operation 415, the now hermetically-sealed bulb assembly may then be removed from the inert-atmosphere glove box. At operation 417, the bulb may be cooled. Cooling the bulb (e.g., by immersing the bulb in liquid nitrogen) helps ensure that the fill materials remain condensed within the bulb during the subsequent sealing operation. Further, the interior of bulb is kept at a low pressure (negative pressure with respect to atmospheric pressure within the glove box) due to the cooling operation. Cooling the bulb helps to shield the fill from the intense heat generated during the second seal.

After the bulb is cooled, a second seal may be made on the bulb (as shown at operation 419). The second seal may be performed relatively quickly (e.g., less than one second) to keep the condensed materials from evaporating during the final seal causing the internal pressure to rise above the outside ambient (atmospheric pressure). The second seal produces a short version of the tail portion 205 as indicated by the arrow 215 on the bulb 201B (see FIG. 2E). A location at which the second seal is made is at least partially dependent on the physical geometry of the bulb. The second seal may be made to avoid or at least reduce producing the hollow passages 213 (FIG. 2D) that can act as local condensation points (cold spots) for the metal halide (or other fill) materials. The second seal is made at a point on the tail intermediate between a terminal portion of the tail and a portion of the bulb containing the cavity, such as indicated by the second seal point 207 of FIG. 2C.

As discussed above, due to physical space restrictions within the glove box, the second seal is generally performed outside the glove box. Also, determining the location of the second seal to avoid the hollow tabulations is more readily performed outside of the high-purity, inert-gas environment. However, in other embodiments, the second seal may be performed within the glove box (or other high purity, ultra-clean environment). In still other embodiments, the first seal is optional and only the second seal is performed, thus producing a short tail (as indicated by the arrow 215 in FIG. 2E) on the bulb with the first seal.

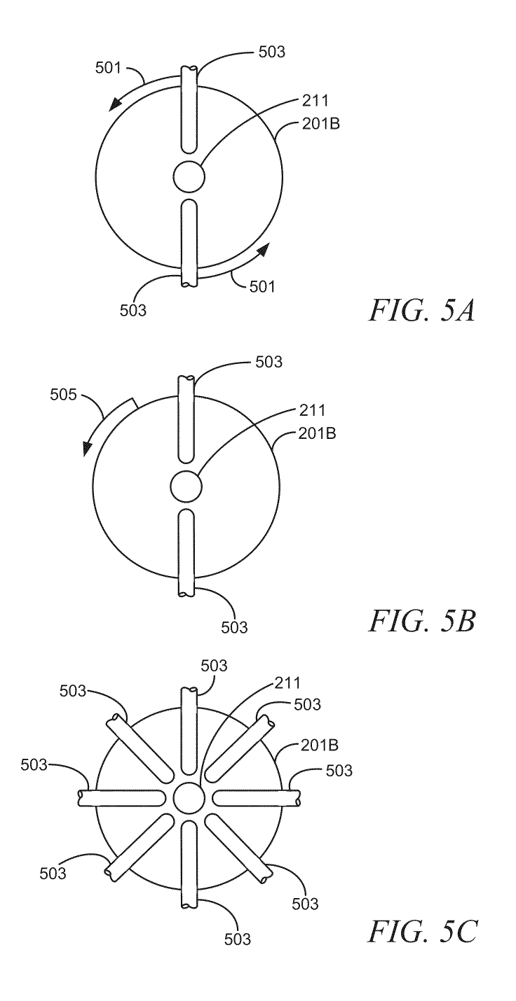

The final seal may be performed using a rotary sealing system. Various embodiments of the rotary sealing systems are described with reference to FIGS. 5A through 5C, below. Mechanically, the various rotary sealing systems are similar to those in current use for sealing bulbs. However, all rotary sealing systems today rely at least partially upon hydrogen for producing the high heat (generally greater than 1800° C. to soften and collapse the quartz but less than 3000° C. to avoid melting the quartz). The amount of hydrogen to which the bulb is exposed during the second seal discussed in the various embodiments is at least reduced by eliminating use of the hydrogen/oxygen torch, described above. Example embodiments may substitute an inert-gas plasma in for of the hydrogen/oxygen torch system currently in use. In one embodiment, an argon jet is sent between at least two sets of electrodes placed at substantially equiangular distances around the axially mounted bulb assembly. A plasma is created by the ohmic heating of the discharge. The discharge, in turn, creates sufficient heat to soften and collapse the quartz tubulation at the bulb surface resulting in the final “short-tail” seal of the bulb.

In other embodiments, gases other than argon are used to produce the inert-gas plasma. For example, any of the inert gases (e.g., helium (He), krypton (Kr), zenon (Ze), or neon (Ne)) may be used to produce the inert-gas plasma. In other embodiments, one or more of the inert gases can be mixed to produce the inert-gas plasma. In general, any gas that is non-reactive and that can be ionized can be used to produce the inert-gas plasma.

Referring now to FIGS. 5A through 5C, various example systems for making a final seal on the bulb are shown. Each of FIGS. 5A through 5C is shown from a view of the bulb 201B of FIG. 2D where the tail portion 205 as indicated by the arrow 211 is oriented closest to the viewer with the main portion of the bulb 201B located directly behind the long-tail. The various orientations of torches, used to soften the quartz in the tail, are arranged around the tail and located in a way to rapidly (e.g., less than one second) apply the heat substantially uniformly to the portion indicated by the arrow 211.

For example, FIG. 5A is shown to include two torches 503 (or electrodes) located substantially 180 degrees apart from one another. As discussed, by way of example, above, an argon jet is directed from each of the two torches 503. A plasma is created by the ohmic heating of the discharge. The discharge, in turn, creates sufficient heat to soften and collapse the quartz tubulation at the bulb surface resulting in the final “short-tail” seal of the bulb. Each of the torches is configured to provide a relative rotational movement between the bulb 201B and the two torches 503. The relative rotational movement is provided by allowing the two torches 503 to rotate in a circular motion 501 around the tail portion 205 as referenced by the arrow 211 as indicated (the actual direction of rotation can be either clockwise or counter-clockwise as long as relative rotational movement is provided).

FIG. 5B is similar to the example system of FIG. 5A. However, in FIG. 5B, each of the two torches remains stationary. The relative rotational movement between the bulb 201B and the two torches 503 is provided by rotating the bulb 201B in a circular motion 505 between the two torches. As with FIG. 5A, the actual direction of rotation can be either clockwise or counter-clockwise as long as relative rotational movement is provided.

In FIG. 5C, once the bulb is located in the system in preparation for a seal, the location between each of the torches 503 and the bulb 201B is stationary. Thus, there is no relative rotational motion. Instead, substantially uniform heat is applied to the portion indicated by the arrow 211 by increasing the number of torches 503. Each of the torches is mounted at substantially equiangular distances around the axially mounted bulb (in the example of FIG. 5C, at 45 degrees apart). The equiangular distances of the torches allow the portion indicated by the arrow 211 to be heated substantially evenly while not requiring any rotating mechanisms.

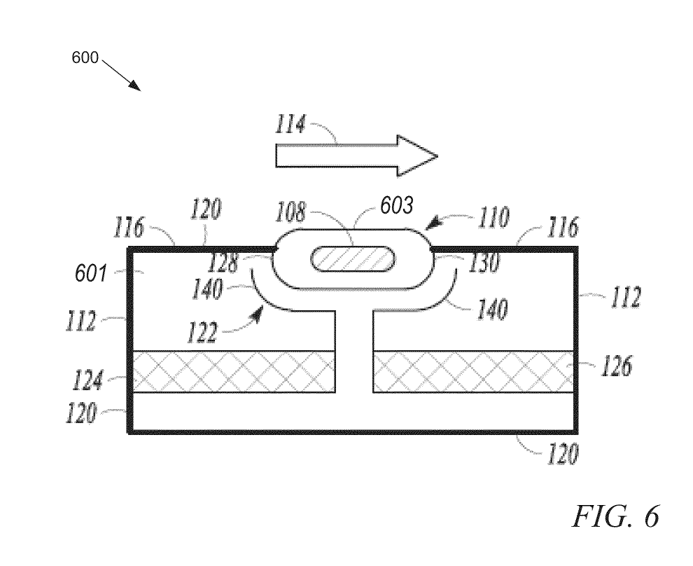

FIG. 6 is a cross-section and schematic view of a plasma lamp 600, according to an example embodiment. The plasma lamp 600 may have a lamp body 601 formed from one or more solid dielectric materials and a bulb 603 positioned adjacent to the lamp body 601. The bulb 603 may be similar to the bulb 201B discussed above. The bulb 603 contains a fill that is capable of forming a light emitting plasma. A lamp drive circuit (not shown) couples RF power into the lamp body 601 which, in turn, is coupled into fill in the bulb 603 to form a light emitting plasma. In example embodiments, the lamp body 601 forms a structure that contains and guides the RF power. The bulb 603 is positioned or oriented in the plasma lamp 600 so that a length of a plasma arc 108 generally faces a lamp opening 110 (as opposed to facing side walls 112 of the lamp body 601) to increase an amount of collectable light emitted from the plasma arc 108 in a given Etendue. Since the length of plasma arc 108 orients in a direction of an applied electric field, the lamp body 601 and the coupled RF power are configured to provide an electric field 114 that is aligned or substantially parallel to the length of the bulb 603 and a front or upper surface 116 of the lamp body 601. Thus, in an example embodiment, the length of the plasma arc 108 may be substantially (if not completely) visible from outside the lamp body 601. In example embodiments, about 40% to 100% (or any range included therein) of the plasma arc 108 may be visible in front of the plasma lamp 600. In example embodiments, a substantial amount of light may be emitted out of the plasma lamp 600 from the plasma arc 108 through a front side wall of the plasma lamp 600 without any internal reflection.

With continuing reference to FIG. 6, the plasma lamp the lamp body 601 includes, in an embodiment, a solid dielectric body and an electrically conductive coating 120, which extends to the front or upper surface 116. The plasma lamp 600 is also shown to include dipole arms 122 and conductive elements 124, 126 (e.g., metalized cylindrical holes bored into the lamp body 601) to concentrate the electric field present in the lamp body 601. The dipole arms 122 may thus define an internal dipole. The dipole arms 122 provide a capacitance and concentrate a high electric field near the bulb 603. The dipole arms 122 extend to end portions 140, which spreads the electric field along the length of the bulb 603. In an example embodiment, a resonant frequency applied to a lamp body 601 without the dipole arms 122 and the conductive elements 124, 126 would result in a high electric field at the center of the lamp body 601. This is based on the intrinsic resonant frequency response of the lamp body due to its shape, dimensions, and relative permittivity. However, in the example embodiment of FIG. 6, the shape of the standing waveform inside the lamp body 601 is substantially modified by the presence of the dipole arms 122 and the conductive elements 124, 126 and the electric field maxima is brought out to ends portions 128, 130 of the bulb 603 using the internal dipole structure. This results in the electric field 114 near the upper surface 116 of the plasma lamp 600 that is substantially parallel to the length of the bulb 603.

The dimensions, shapes, materials, and operating parameters are examples only and other embodiments may use different dimensions, shapes, materials, and operating parameters. Additionally, although the various embodiments have been described relative to a quartz bulb, the embodiments can also be applied to bulbs of other materials such as sapphire, ceramic, or other desired bulb material. Further, the various embodiments are described with reference to a cylindrical bulb. However, upon reading the disclosure provided herein, a person of skill in the art can readily apply the same methods, techniques, and systems to pill shaped, spherical, or other desired shapes of bulbs.

What is claimed is:

1. A method of forming a seal on an electrodeless bulb for use in a plasma lamp, the method comprising:
reducing a cross-sectional diameter of a first end of a tube to form a tail on the electrodeless bulb, the tail being open to an interior portion of the bulb, the interior portion forming a cavity;
injecting one or more fill gases into the cavity of the bulb;
sealing a first portion along the tail of the bulb thereby forming a truncated tail; and
sealing a second point on the tail intermediate between a terminal portion of the truncated tail and a portion of the bulb containing the cavity, the second point being sealed with a plasma torch by using an inert-gas element with a minimum of hydrogen gas.

2. The method of claim 1, further comprising:
providing a section of tube;
cutting the tube to length;
placing the tube into a high purity environment; and
sealing an end opposite the first end of the tube in a rounded fashion to form a first end of the electrodeless bulb;

3. The method of claim 1, further comprising removing the bulb from the high purity environment prior to sealing the second point on the tail.

4. The method of claim 1, further comprising selecting argon to be the inert-gas element.

5. The method of claim 1, further comprising selecting the inert-gas element from a group consisting of helium, krypton, xenon, and neon.

6. The method of claim 1, further comprising providing relative rotational movement between the bulb and the plasma torch.

7. The method of claim 1, wherein a selection of the inert-gas element excludes hydrogen.

8. The method of claim 1, wherein the sealing is performed by applying heat to the bulb.

9. The method of claim 8, further comprising selecting a temperature of the heat applied to the bulb to be about 1800 degrees Celsius.

10. The method of claim 1, further comprising cooling the bulb to a temperature of less than −100 degrees Celsius prior to sealing the second point.

11. The method of claim 10, wherein the cooling of the bulb is accomplished by placing the bulb in a liquid nitrogen bath.

12. The method of claim 1, further comprising selecting a location of the seal on the second point as to prevent forming a hollow passage within the bulb.

13. The method of claim 1, further comprising adding a chemical dose prior to sealing a first portion along the tail of the bulb thereby forming a truncated tail.

14. The method of claim 1, further comprising baking the bulb to reduce a level of hydrogen prior to injecting one or more fill gases into the cavity of the bulb.
